(19) United States
(12) Patent Application Publication
(10) Pub. No.: US 2023/0068632 A1
(43) Pub. Date: Mar. 2, 2023

(54) MANAGEMENT DEVICE, METHOD, AND POWER MANAGEMENT SYSTEM

(71) Applicant: TOYOTA JIDOSHA KABUSHIKI KAISHA, Toyota-shi (JP)

(72) Inventors: Yuki KUDO, Susono-shi (JP); Kazutaka KIMURA, Mishima-shi (JP); Kazuki OBATA, Susono-shi (JP); Hiromitsu KIGURE, Ashigarakami-gun (JP); Satoshi KIKUCHI, Hadano-shi (JP); Yuta MANIWA, Susono-shi (JP)

(73) Assignee: TOYOTA JIDOSHA KABUSHIKI KAISHA, Toyota-shi (JP)

(21) Appl. No.: 17/810,126

(22) Filed: Jun. 30, 2022

(30) Foreign Application Priority Data
Aug. 24, 2021 (JP) 2021-136272

(51) Int. Cl. H02J 3/14; H02J 3/00

(52) U.S. Cl. CPC H02J 3/144; H02J 3/003

(57) ABSTRACT

A market server receives a second request signal for requesting reception-supply adjustment of a first amount of power from a CEMS server and sends an invitation signal to a plurality of agent devices. The market server receives a bid signal showing bid conditions for a power buying or selling transaction of a second amount of power, smaller than the first amount of power, from at least one or more agent devices that have determined the bid conditions among the plurality of agent devices, and accepts bids by the at least one or more agent devices when acceptance conditions are met.

### CROSS-REFERENCE TO RELATED APPLICATION

This application claims priority to Japanese Patent Application No. 2021-136272 filed on Aug. 24, 2021, incorporated herein by reference in its entirety.

### BACKGROUND

### 1. Technical Field

This disclosure relates to a management device, a method, and a power management system.

### 2. Description of Related Art

Japanese Unexamined Patent Application Publication No. 2021-118618 (JP 2021-118618 A) discloses an energy management system adopting a configuration of a so-called virtual power plant (VPP). This energy management system includes an aggregation coordinator and N (N is an integer not less than two) resource aggregators. For example, the resource aggregator is provided in each community. In the community, one or more power resources are disposed. The power resources charge and discharge power. The resource aggregator transmits and receives power to and from the power resource in the community. The aggregation coordinator aggregates the amounts of power transmitted and received by the resource aggregators and executes a power transaction with a power company (e.g., a power transmission and distribution company or a power retailer).

### SUMMARY

In the technology described in JP 2021-118618 A, the power company may output a request for a transaction of a large amount (e.g., in the unit of MWh) of power (hereinafter also referred to as a “major request”) to the aggregation coordinator. A power transaction is selling of power and buying of power. In this case, the aggregation coordinator creates N requests into which the large amount of power specified by the major request is divided (hereinafter also referred to as “minor requests”). Then, the aggregation coordinator sends the N minor requests respectively to the N resource aggregators. Each resource aggregator executes a power transaction in accordance with the minor request with one or more power resources associated with that resource aggregator. By aggregating power transactions in accordance with the N minor requests, the aggregation coordinator realizes a power transaction in accordance with the major request.

However, there is a case such as where power resources that can deal with a power transaction in accordance with a minor request are small in number. In this case, the resource aggregator associated with these small number of power resources cannot meet the minor request, so that the aggregation coordinator may fail to realize a power transaction in accordance with the major request. Thus, with power transactions frequently executed these days, there is a need for a technology that can realize a more flexible power transaction.

This disclosure has been contrived to solve this problem, and an object of the disclosure is to realize a more flexible power transaction.

A management device according to this disclosure is a management device of a power transaction market. The management device includes a processor, and an interface capable of communicating with a plurality of agent devices and another management device. Each of the plurality of agent devices determines bid conditions for a power buying or selling transaction in the power transaction market. The processor receives a request signal for requesting reception-supply adjustment of a first amount of power from the other management device. The processor sends an invitation signal for inviting bids in accordance with the request signal to the plurality of agent devices. The processor receives a bid signal showing the bid conditions for a power buying or selling transaction of a second amount of power, smaller than the first amount of power, from at least one or more agent devices that have determined the bid conditions among the plurality of agent devices having received the invitation signal. The processor accepts bids by the at least one or more agent devices when acceptance conditions are met.

This configuration can realize a bid in accordance with the request signal for requesting reception-supply adjustment of the first amount of power by means of the plurality of agent devices. Thus, it can realize a more flexible power transaction.

The acceptance conditions may include a condition that is met when a total value of second amounts of power included in bid conditions shown by the bid signals received from the at least one or more agent devices reaches the first amount of power.

In this configuration, bids are accepted when the total value of the second amounts of power included in the bid conditions from the at least one or more agent devices reaches the first amount of power that is an amount requested by the other management device. Thus, a power transaction in accordance with the request can be realized.

The acceptance conditions may include a condition that is met when a total value of second amounts of power included in bid conditions shown by the bid signals received from the at least one or more agent devices reaches a third amount of power, smaller than the first amount of power, and moreover a time of day specified by the management device is reached.

In this configuration, even when the total value of the second amounts of power is smaller than the first amount of power that is an amount requested by the other management device, the bids are accepted as the time of day specified by the management device is reached. Thus, the management device can reduce the loss of opportunities for power transactions.

When a total value of second amounts of power shown by the bid signals received from the at least one or more agent devices reaches a fourth amount of power, larger than the first amount of power, the management device may send an excess signal showing that the total value has reached the fourth amount of power to the other management device.

This configuration allows the other management device to recognize that the total value of the second amounts of power has exceeded the first amount of power that is an amount requested by the other management device. Thus, the other management device can execute control such as making other resources process the power corresponding to the difference between the total value and the first amount of power.

The management device may accept bids by the at least one or more agent devices based on a degree of priority that is set for each of the at least one or more agent devices.

This configuration can realize a smoother power transaction by accepting bids by agent devices having a high degree of priority.

Each of the plurality of agent devices may be associated with an electrified vehicle that executes power processing that is at least one of charging and discharging of power being traded. The management device may set the degree of priority such that an agent device that is associated with a specific vehicle that is at least one of an electrified vehicle for which a travel plan is determined and an electrified vehicle that performs autonomous driving has a higher degree of priority than an agent device that is not associated with the specific vehicle.

This configuration can reduce the occurrence of a problem such as that a power transaction is not executed according to bid conditions.

Each of the plurality of agent devices may be associated with a power unit that executes power processing that is at least one of charging and discharging of power being traded. Power traded in the power transaction market may include first traded power and second traded power. The first traded power is power of which generating a unit amount emits a first amount of carbon dioxide. The second traded power is power of which generating the unit amount emits a second amount, smaller than the first amount, of carbon dioxide. The management device may set the degree of priority such that an agent device associated with a power unit that executes the power processing of the second traded power has a higher degree of priority than an agent device associated with a power unit that executes the power processing of the first traded power.

This configuration can promote execution of power transactions that contribute to global environmental protection.

Each of the plurality of agent devices may be associated with a power unit that executes power processing that is at least one of charging and discharging of power being traded. The power unit may exchange power via a power relay facility. The management device may set the degree of priority such that an agent device associated with a power unit that is located at a first distance from the power relay facility has a higher degree of priority than an agent device associated with a power unit that is located at a second distance, longer than the first distance, from the power relay facility.

This configuration can reduce the power transmission loss over a power transmission line from the power unit to the power relay facility.

The management device may further include a memory that stores an agent ID of an agent device and an evaluation point of the agent device so as to be associated with each other. The management device may update the evaluation point based on at least one of a history of past transactions executed by the agent device and contents of the bid conditions shown by the bid signal received from the agent device. The management device may set the degree of priority such that an agent device of which the evaluation point is a first point has a higher degree of priority than an agent device of which the evaluation point is a second point, lower than the first point.

This configuration can encourage users of the agent devices to make power transactions and bid conditions more suitable.

A method of this disclosure is a method using a plurality of agent devices and a management device of a power transaction market. Each of the plurality of agent devices determines bid conditions for a power buying or selling transaction in the power transaction market. The method includes receiving a request signal for requesting reception-supply adjustment of a first amount of power from another management device. The method includes sending an invitation signal for inviting bids in accordance with the request signal to the plurality of agent devices. The method includes receiving a bid signal showing the bid conditions for a power buying or selling transaction of a second amount of power, smaller than the first amount of power, from at least one or more agent devices that have determined the bid conditions among the plurality of agent devices having received the invitation signal. The method includes accepting bids by the at least one or more agent devices when acceptance conditions are met.

This configuration can realize a bid in accordance with the request signal for requesting reception-supply adjustment of the first amount of power by means of the plurality of agent devices. Thus, it can realize a more flexible power transaction.

A power management system of this disclosure includes a first management device, a second management device, a power adjustment resource, a third management device, a fourth management device, and a plurality of agent devices. The first management device outputs a request signal requesting reception-supply adjustment of an amount of power. The second management device outputs a first request signal and a second request signal based on the request signal. The third management device adjusts power of the power adjustment resource based on the first request signal output from the second management device. The second request signal is a signal for requesting reception-supply adjustment of a first amount of power. Each of the plurality of agent devices determines bid conditions for a power buying or selling transaction in the power transaction market. The fourth management device sends an invitation signal for inviting bids in accordance with the second request signal to the plurality of agent devices. The fourth management device receives a bid signal showing the bid conditions for a power buying or selling transaction of a second amount of power, smaller than the first amount of power, from at least one or more agent devices that have determined the bid conditions among the plurality of agent devices having received the invitation signal. The fourth management device accepts bids by the at least one or more agent devices when acceptance conditions are met.

This configuration can realize a bid in accordance with the request signal for requesting reception-supply adjustment of the first amount of power by means of the plurality of agent devices. Thus, it can realize a more flexible power transaction.

This disclosure can realize a bid in accordance with the request signal for requesting reception-supply adjustment of the first amount of power by means of the plurality of agent devices. Thus, it can realize a more flexible power transaction.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a power management system of an embodiment;

FIG. 2 is a chart showing timings of sending a second request signal etc.;

FIG. 3 is a table summarizing the contents specified by signals including a request signal;

FIG. 4 is a diagram showing an example of the configuration of main devices of the power management system;

FIG. 5 is a diagram showing the hardware configurations of an agent device and a market server;

FIG. 6 is a view showing one example of an input screen displayed in the agent device;

FIG. 7 is a table showing one example of a participant database;

FIG. 8 is a functional block diagram of the agent device and the market server;

FIG. 9 is a table showing bid conditions temporarily stored in a temporary storage unit;

FIG. 10 is a table showing degree-of-priority conditions;

FIG. 11 is a table showing one example of an increase and a decrease in an evaluation point;

FIG. 12 is a table showing suitability conditions;

FIG. 13 is a flowchart showing a main process of the market server; and

FIG. 14 is a flowchart showing a main process of the market server in another embodiment.

### DETAILED DESCRIPTION OF EMBODIMENTS

Embodiments of this disclosure will be described in detail below with reference to the drawings. The same or equivalent parts in the drawings are denoted by the same reference signs and will not be repeatedly described.

### First Embodiment

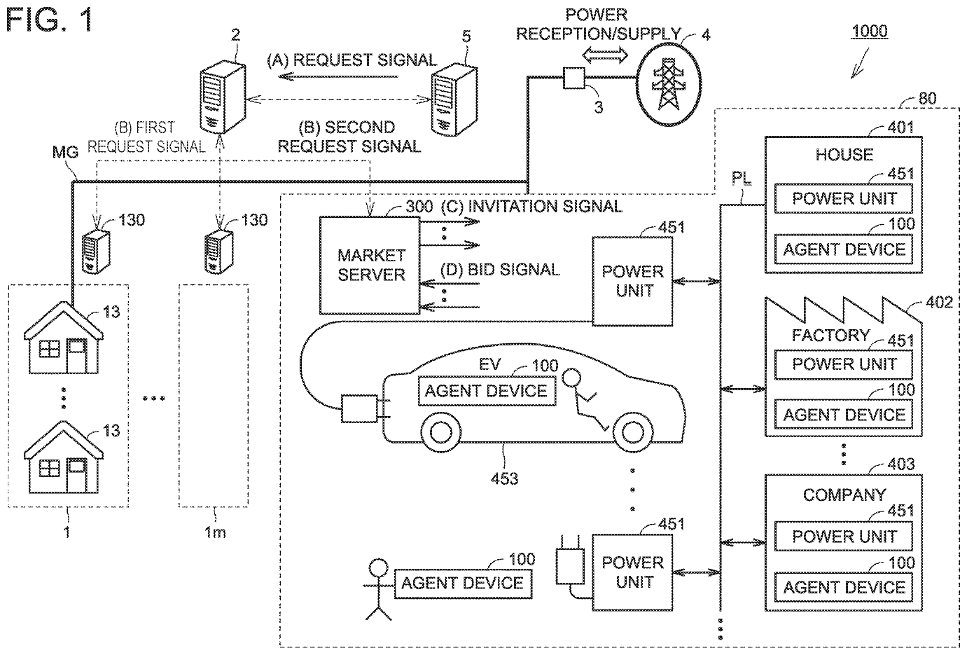

FIG. 1 is a diagram showing a schematic configuration of a power management system 1000 of this embodiment. The power management system 1000 includes m (m is an integer not less than one) CEMS 1, a CEMS server 2, a power receiving-transforming facility 3, a power system 4, a power transmission and distribution company's server (hereinafter also referred to simply as a “company server 5”), and a power transaction system 80. “CEMS” means a community energy management system or a city energy management system. In the CEMS 1, a microgrid MG is established. The microgrid MG is typically a “power network.”

The CEMS 1 of FIG. 1 is a system that manages demand and supply of power used in households. One or more home energy management systems belong to this CEMS 1. Hereinafter, the home energy management system will also be referred to as an HEMS 13. The HEMS 13 includes household devices that operate on power supplied from the microgrid MG (air conditioners, lighting apparatuses, and other electric products). The HEMS 13 may further include pieces of equipment such as a solar panel, a household heat pump system, a household cogeneration system, a household storage battery, and a power generator. The HEMS 11 corresponds to one example of the “power adjustment resource” according to this disclosure. Hereinafter, the power adjustment resource will also be referred to as a “power resource.” Adjustment of power by the power resource typically means exchange of power (input of power and output of power). For example, an owner of the power resource sells power output from the power resource or buys power input into the power resource.

An individual server 130 is installed in association with each HEMS 11. The individual server 130 can perform bidirectional communication with the CEMS server 2.

The power management system 1000 may include other CEMSs. The other CEMSs include at least one of a factory energy management system (FEMS), a building energy management system (BEMS), a power generator, a natural variable power source, an energy storage system (ESS), an electric vehicle supply equipment (EVSE), a vehicle, and a heat storage system.

The CEMS server 2 is a computer that manages the power resources in the CEMS 1. The CEMS server 2 may be an aggregator server. The aggregator server is a server of an electricity supplier that provides an energy management service by aggregating a plurality of power resources.

The power receiving-transforming facility 3 is provided at a power receiving point (connection point) of the microgrid MG and configured to be able to switch between parallel-in (connection) and parallel-off (disconnection) between the microgrid MG and the power system 4. While this is not shown, the power receiving-transforming facility 3 includes a switchgear on a high-voltage side (primary side), a transformer, a protection relay, a measurement instrument, a control device, and the like. While the microgrid MG is connected to the power system 4, the power receiving-transforming facility 3 receives, for example, alternating-current power of a special high voltage (a voltage exceeding 7000 V) from the power system 4, and steps down the received power before supplying it to the microgrid MG. The number of the power receiving-transforming facility 3 is at least one.

The power system 4 is a power network formed by a power plant and a power transmission and distribution facility. In this embodiment, a power company acts both as a power generation company and a power transmission and distribution company. The power company corresponds to a general power transmission and distribution company and a manager of the power system 4, and maintains and manages the power system 4. The power system 4 outputs (supplies) power to an outside (discharges power) and receives input of power from the outside (receives power).

The company server 5 is a computer that belongs to the power company and manages demand and supply of power in the power system 4. The company server 5 is also configured to be able to perform bidirectional communication with the CEMS server 2.

Next, a power transaction system 80 will be described. In the power transaction system 80, a power transaction market adopting a so-called peer-to-peer (P2P) power transaction is realized. Thus, in one aspect, the power management system 1000 is a system that integrates the idea of the VPP and the idea of the P2P power transaction. A “power transaction” includes both buying of power and selling of power. In the example of FIG. 1, the power transaction system 80 mainly includes agent devices 100, a market server 300, and power units 451.

The power units 451 can generate and output (discharge) power. The power units 451 can also receive power from an outside and input (charge) the power. In the example shown in FIG. 1, the power units 451 are disposed in a house 401, a factory 402, and a company 403.

For example, the power units 451 can charge power to a device that operates on electricity (hereinafter also referred to as an “electrically operated device 453”). For example, the electrically operated device 453 is a movable body. The movable body is typically an electrified vehicle equipped with a battery for travel, and is, for example, an electric vehicle (EV), a hybrid-electric vehicle (HEV), or a plug-in hybrid electric vehicle (PHEV). In the example of FIG. 1, one power unit 451 can transmit power to another power unit 451 through a power transmission line PL.

As shown in FIG. 1, the agent device 100 may be included in an onboard device of the electrically operated device 453 (movable body). The agent device 100 may be included in the power unit 451. The agent device 100 may be formed by a personal computer (PC), a tablet, a smartphone, or the like. In the example shown in FIG. 1, the electrically operated device 453 is a movable body and the agent device 100 is installed in an onboard device of this movable body. In the example shown in FIG. 1, the agent device 100 is a smartphone held by a person. In the example shown in FIG. 1, the agent device 100 is a PC disposed in the house 401, the factory 402, and the company 403.

The company server 5 corresponds to one example of the “first management device” according to this disclosure. The CEMS server 2 corresponds to one example of the “second management device” or the “other management device” according to this disclosure. The individual server 130 corresponds to one example of the “third management device” according to this disclosure. The market server 300 corresponds to one example of the “fourth management device” or the “management device” according to this disclosure.

Next, a request from the company server 5 will be described. For example, the following first situation or second situation relating to power can arise. For example, the first situation is a situation where the power company to which the company server 5 belongs has generated an excessive amount of power or where it is expected that the power company will generate an excessive amount of power. For example, the second situation is a situation where there is an excessive power shortage or where it is expected that there will be an excessive power shortage.

In the case of the first situation, it is preferable for the power company to sell the surplus power (discharge the power). On the other hand, in the case of the second situation, it is preferable for the power company to buy power (charges power) to cover the shortage.

Therefore, when the first situation or the second situation arises, the manager of the company server 5 etc. operates the company server 5 to make the company server 5 output a request signal. The request from the company server 5 corresponds to an increase demand response (DR) or a decrease demand response (DR).

In the case of the first situation, the manager performs an operation according to the first situation on the company server 5. This operation causes the company server 5 to output a request signal for selling the surplus power to the CEMS server 2. On the other hand, in the case of the second situation, the manager performs an operation according to the second situation on the company server 5. This operation causes the company server 5 to output a request signal for buying power to cover the shortage to the CEMS server 2. Thus, in step (A), the company server 5 outputs a request signal to the CEMS server 2. The request signal is a signal requesting reception-supply adjustment of an amount of power. Specifically, the request signal specifies the amount of surplus power or the amount of power shortage. The specified amount of power is assumed to be A (MWh). Thus, the amount of power specified by the request signal is in the unit of MWh, which is a large amount of power.

The request signal further specifies a requested start time, a requested end time, and a requested price. However, the request signal need not include the requested price. The requested start time and the requested end time are times of day for defining a requested time span. When the request signal is a signal for selling surplus power, the requested start time is a start time from which power can be output from the power system 4, and the requested end time is an end time until which power can be output from the power system 4. When the request signal is a signal for buying power to cover a shortage, the requested start time is a start time from which power can be input from the power system 4, and the requested end time is an end time until which power can be input from the power system 4. The requested price is the price of an amount of power A to be described later.

Using a predetermined first algorithm, the CEMS server 2 divides the power of the amount of power A (MWh) specified by the request signal into power that is to be adjusted in the M CEMSs 1 and power that is to be adjusted in the power transaction system 80. Further, using the predetermined first algorithm, the CEMS server 2 divides a requested price B (yen) of power specified by the request signal into a price that is paid by (or paid to) the m CEMSs 1 and a price that is paid by (or paid to) the power transaction system 80.

In the following, portions of the power to be adjusted in the m CEMSs 1 will be respectively represented by “A1, A2, . . . Am.” The power to be adjusted in the power transaction system 80 will be represented by Ap. Thus, the following Formula (1) holds:

A=A1+A2+ . . . +Am+Ap (1)

The prices respectively paid by (or paid to) the m CEMSs 1 will be represented by “B1, B2, Bm.” The price paid by (or paid to) the power transaction system 80 will be represented by Bp. Thus, the following Formula (2) holds:

B=B1+B2+ . . . +Bm+Bp (2)

Based on the request signal from the company server 5, the CEMS server 2 generates m first request signals and one second request signal. The m first request signals respectively specify A1, A2, . . . Am, and the requested start time and the requested end time described above. The CEMS server 2 sends the m first request signals respectively to the m individual servers 130. Each of the m individual servers 130 makes the power resource 13 in the CEMS 1 associated with that individual server 130 adjust the power of the amount of power shown by the first request signal. Thus, the individual server 130 functions to adjust the power of the amount of power shown by the first request signal.

The CEMS server 2 sends the second request signal to the market server 300. In this embodiment, the second request signal specifies the amount of power Ap, the power price Bp, the requested start time, and the requested end time. The amount of power Ap corresponds to one example of the “first amount of power” of this disclosure. The second request signal is a signal for requesting reception-supply adjustment of the first amount of power. The first amount of power is an amount of power not less than 1 MWh.

Thus, in step (B), the CEMS server 2 sends the m first request signals respectively to the m individual servers 130 and sends one second request signal to the market server 300.

For example, when the request signal from the company server 5 is a signal for requesting selling of surplus power, the second request signal is a signal for requesting selling of power of the amount of power Ap. Therefore, the agent device 100 can bid for buying power.

When the request signal from the company server 5 is a signal for requesting buying of power to cover a shortage, the second request signal is a signal for requesting buying of power of the amount of power Ap. Therefore, the agent device 100 can bid for selling power.

Next, in step (C), the market server 300 sends an invitation signal to the plurality of agent devices 100. Here, the invitation signal is a signal for inviting to a bid in accordance with the second request signal. The agent devices 100 that have received this invitation signal can bid for power of the amount of power Ap specified by the second request signal. That is, those agent devices 100 can bid for selling power or bid for buying power.

The agent devices 100 that have received the invitation signal determine bid conditions as will be described later. Then, the agent devices 100 send the determined bid conditions to the market server 300. In step (D), the market server 300 receives bid signals from one or more agent devices 100.

Thereafter, each of the m individual servers 130 generates a first result signal (not shown) showing the adjustment result and sends the first result signal to the CEMS server 2. Further, the market server 300 integrates the results of the bid signals from the one or more agent devices 100 to generate a second result signal (not shown), and sends the second result signal to the CEMS server 2.

The CEMS server 2 integrates the m first result signals and the one second result signal to generate a result signal, and sends the result signal to the company server 5.

The market server 300 administers power transactions in a region where the plurality of power units 451 is present. The power management system 1000 has one power transaction system 80 in the example of FIG. 1, but the power management system 1000 may have a plurality of power transaction systems 80.

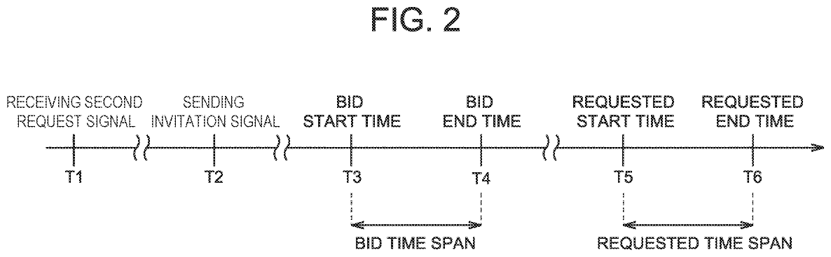

In a situation where the company server 5 has not outputted a request signal, the power transaction system 80 realizes a normal P2P power transaction. A normal P2P power transaction is a power transaction between individuals. For example, in the example of FIG. 2, it is a power transaction realized between the agent device 100 owned by a manager of the factory 402 (user) and the agent device 100 owned by a manager of the electrically operated device 453 (electrified vehicle). In a normal P2P power transaction, the market server 300 manages the power transaction.

FIG. 2 is a chart showing timings of the second request signal, the invitation signal, the bid start time, the bid end time, the requested start time, and the requested end time, etc. The horizontal axis of FIG. 2 is a time axis.

As shown in FIG. 2, the timing when the market server 300 receives the second request signal from the CEMS server 2 (timing (A) in FIG. 1) is timing T1. Next, the timing when the market server 300 sends the invitation signal to the agent devices 100 (timing (B) in FIG. 1) is timing T2.

The invitation signal sent at timing T2 includes the bid start time and the bid end time. The bid start time is a start time from which the agent devices 100 can bid. The bid end time is an end time until which the agent devices 100 can bid. The bid start time is timing T3. The bid end time is timing T4. As described above, the second request signal sent at timing T1 specifies the requested start time and the requested end time. The requested start time is timing T5. The requested end time is timing T6.

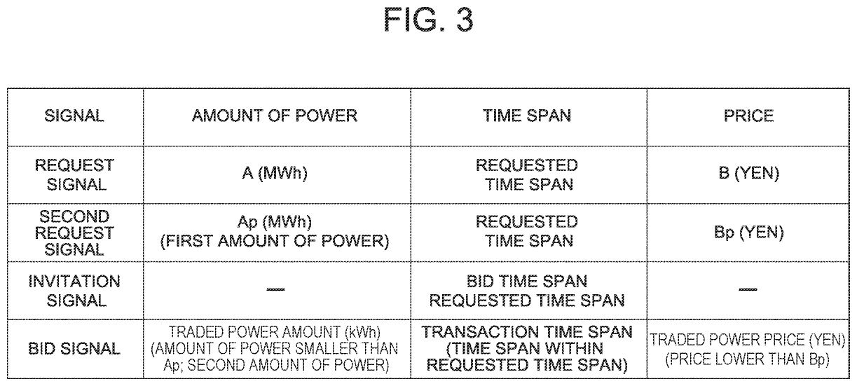

FIG. 3 is a table summarizing the contents specified by the request signal, the second request signal, the invitation signal, and the bid signal. As shown in FIG. 3, the request signal specifies the amount of power A (MWh), the requested time span, and the power price B (yen). The second request signal specifies the amount of power Ap (MWh), the requested time span, and the power price Bp (yen).

The invitation signal specifies the bid time span and the requested time span but does not specify the amount of power and the price. The requested time span specified by the second request signal and the invitation signal is the same as the requested time span specified by the request signal. The bid time span is determined by the market server 300. The bid signal specifies a traded power amount, a transaction time span, and a traded power price. The traded power amount, the transaction time span, and the traded power price will be described later.

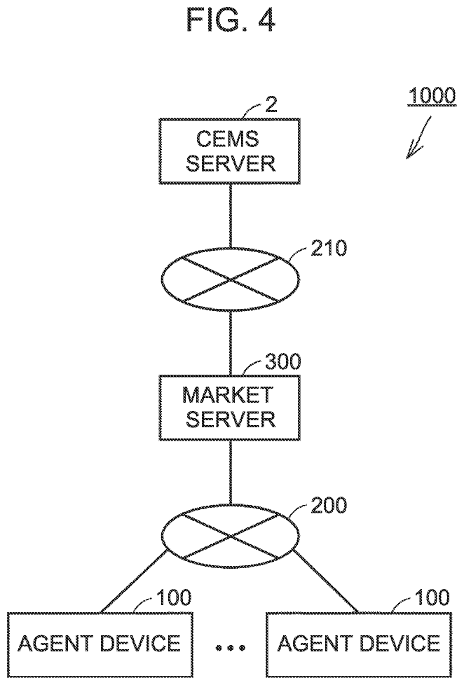

FIG. 4 is a diagram showing the power management system 1000 with main devices represented from a viewpoint different from that of FIG. 1. The power management system 1000 mainly includes the market server 300, the plurality of agent devices 100, the CEMS server 2, a network 200, and a network 210. The agent devices 100 and the market server 300 can communicate with each other through the network 200. The market server 300 and the CEMS server 2 can communicate with each other through the network 210.

Hardware Configuration

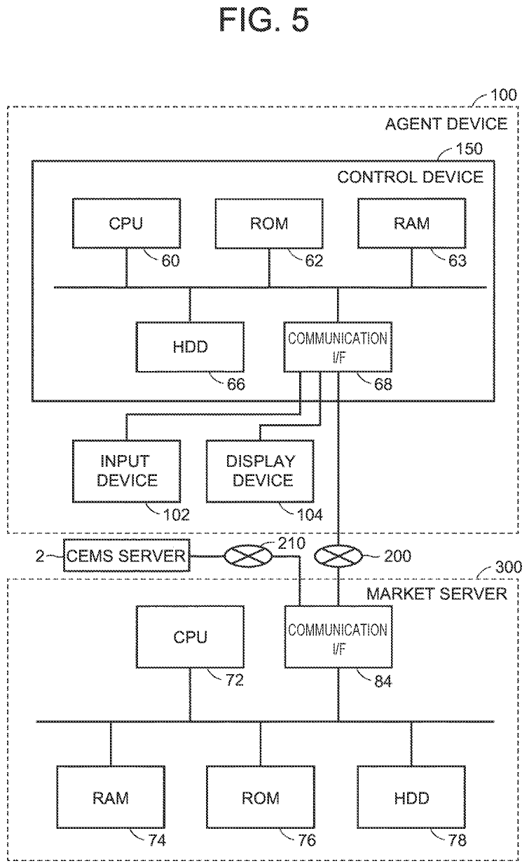

FIG. 5 is a diagram showing the hardware configurations of the agent device 100 and the market server 300. The agent device 100 includes a control device 150, an input device 102, and a display device 104. The control device 150 has a central processing unit (CPU) 60, a storage unit that stores programs and data, and a communication interface (I/F) 68. These components are connected to one another through a data bus. When the agent device 100 is installed in an onboard device, the CPU 60 is substituted by an electronic control unit (ECU).

The storage unit includes a read-only memory (ROM) 62, a random-access memory (RAM) 63, and a hard disk drive (HDD) 66. The ROM 62 can store programs to be executed in the CPU 60. The RAM 63 can temporarily store data created as a result of execution of programs in the CPU 60 and data input via the communication I/F 68, and can function as a temporary data memory that is used as a work area. The HDD 66 is a non-volatile storage device and can store various pieces of information. Instead of the HDD 66, a semiconductor storage device, such as a flash memory, may be used.

The communication I/F 68 is an interface for communicating with the market server 300 through the network 200. The communication I/F 68 can communicate with the input device 102 and the display device 104.

The input device 102 is a pointing device, such as a keyboard or a mouse, and receives operation by a user. The display device 104 is formed by, for example, a liquid crystal display (LCD) panel, and displays information to the user. When a touch panel is used as a user interface, the input device 102 and the display device 104 are integrally formed.

The market server 300 has a CPU 72, a storage unit (an ROM 76, an RAM 74, and an HDD 78), and a communication I/F 84.

The ROM 76 can store programs to be executed in the CPU 72. The RAM 74 can function as a data memory that can temporarily store data created as a result of execution of programs in the CPU 72, data from the agent devices 100, and other data. The HDD 78 is a non-volatile storage device and can store information generated in the market server 300. Instead of the HDD 78, a semiconductor storage device, such as a flash memory, may be used. The communication I/F 84 is an interface for communicating with the agent devices 100 through the network 200. The communication I/F 84 is an interface for communicating with the CEMS server 2 through the network 210.

While the hardware configurations of the individual server 130, the CEMS server 2, and the company server 5 are not shown, the individual server 130, the CEMS server 2, and the company server 5 typically have the same configurations as the market server 300.

Bid Conditions

Each of the plurality of agent devices 100 described with FIG. 1 etc. can determine bid conditions for a power buying or selling transaction in the power transaction market. For example, the agent devices 100 that have received the above-described invitation signal can automatically determine the bid conditions based on a predetermined bid algorithm. In this embodiment, the bid conditions include the traded power amount, the transaction time span, and the traded power price. The traded power amount, the transaction time span, and the traded power price are parameters shown in the “bid signal” of FIG. 3.

The traded power amount shows an amount of power that is traded when the bid conditions including that traded power amount are accepted. The transaction time span shows a time span in which a transaction is executed when the bid conditions including that transaction time span are accepted. The traded power price shows a price of power at which power is traded when the bid conditions including that traded power price are accepted.

For example, each agent device 100 is associated with at least one of the power unit 451 and the electrically operated device 453. Using predetermined parameters, the agent device 100 determines the bid conditions based on the aforementioned bid algorithm. For example, the predetermined parameters include at least one of the following: the amount of power remaining in the electrically operated device 453, a future action of the electrically operated device 453 that consumes power, and maximization of the profit of the user of the agent device 100 in the power transaction. For example, when the electrically operated device 453 is the aforementioned electrified vehicle, the agent device 100 determines the power required for the electrified vehicle to travel by determining a state-of-charge (SOC) of the electrified vehicle and a route of the electrified vehicle (i.e., a commuting route of a driver of the electrified vehicle). Then, the agent device 100 determines the bid conditions for the required power such that the profit of the user is maximized (e.g., power can be bought at the lowest price).

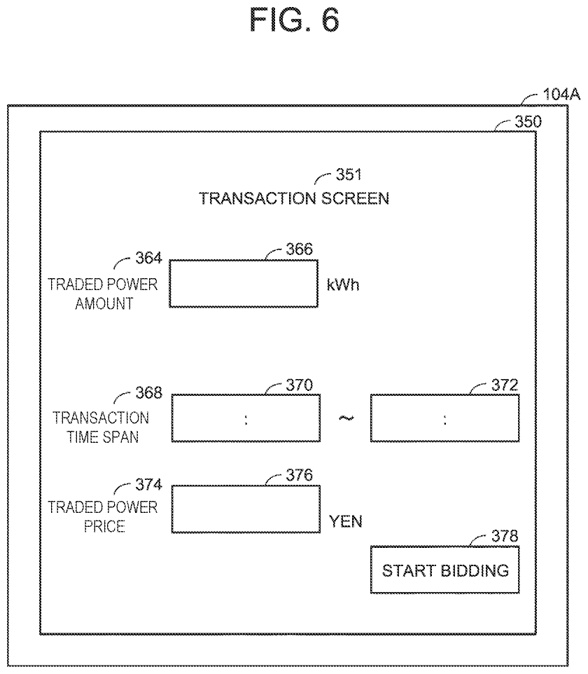

The agent device 100 also allows the user of the agent device 100 to manually determine the bid conditions. Specifically, the agent device 100 can receive input of bid conditions from the user through an input screen. FIG. 6 is one example of an input screen 350 displayed in a display area 104A of the display device 104 of the agent device 100. The agent device 100 that has received the invitation signal can display the input screen 350 on the display device 104 for the time span from the bid start time to the bid end time (i.e., the bid time span) described with FIG. 2. A bidder (the owner of the agent device 100) inputs bid conditions into the input screen 350 using the input device 102. A bidder is also referred to as a user. A bidder trying to buy power is also referred to as a “power buyer,” and a bidder trying to sell power is also referred to as a “power seller.”

A character image 351 “transaction screen” is displayed in the input screen 350. In the input screen 350, an input section 364 “traded power amount” is also displayed. An input field 366 for the traded power amount is displayed in association with the input section 364. The bidder can input a numeral value of the traded power amount into this input field 366. The bidder can participate in the power transaction market as a power buyer or a power seller with the traded power amount that has been input into the input field 366.

In the input screen 350, an input section 368 “transaction time span” is also displayed. An input field 370 for the start time of the transaction time span and an input field 372 for the end time of the transaction time span are displayed in association with the input section 368. The bidder can input the start time of the power transaction into the input field 370 and input the end time of the power transaction into the input field 372. The bidder can participate in the power transaction market as a power buyer or a power seller with the transaction time span that has been input into the input field 370 and the input field 372.

In the input screen 350, an input section 374 “traded power price” is also displayed. An input field 376 for the traded power price is displayed in association with the input section 374. The bidder can input a numerical value of the power price into the input field 376. The bidder can participate in the power transaction market as a power buyer or a power seller with the power price that has been input into the input field 376.

In the input screen 350, a “start bidding” button 378 is displayed. After the bidder inputs the traded power amount, the transaction time span, and the traded power price, the bidder can manipulate the “start bidding” button 378. By manipulating the “start bidding” button 378, the bidder can bid in response to the invitation shown by the above-described invitation signal.

Typically, the unit of the traded power amount that is automatically determined by the agent device 100 is “kWh.” On the other hand, the unit of the above-described first amount of power is “MWh.” Thus, the traded power amount that is automatically determined by the agent device 100 is smaller than the first amount of power. The unit of the traded power amount that is input into the input field 366 of the input screen 350 is also “kWh.” Thus, the traded power amount that is input into the input field 366 is also smaller than the first amount of power.

As has been described, the traded power amount that is specified by the bid conditions automatically determined by the agent device 100 or manually determined by the bidder is smaller than the first amount of power. Hereinafter, the traded power amount that is specified by the bid conditions will also be referred to as a “second amount of power.”

Database

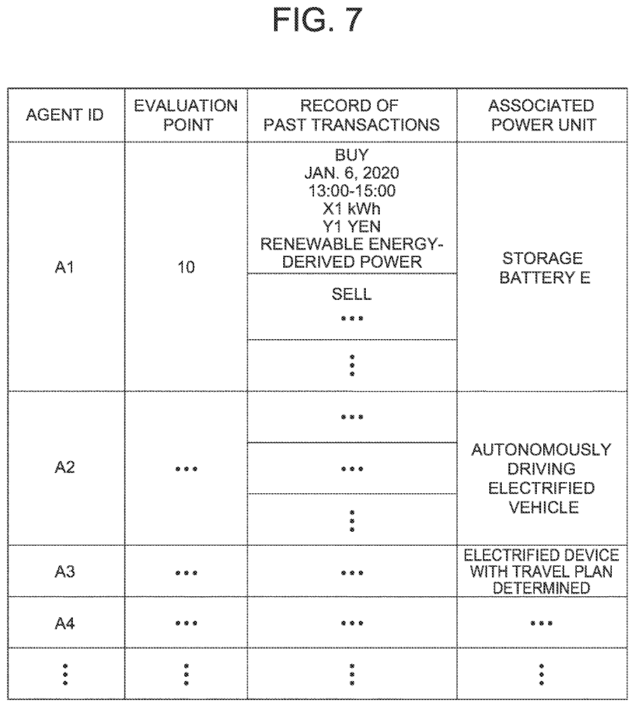

Next, a database used in the power transaction system 80 of this embodiment will be described. FIG. 7 is one example of a participant database. The participant database is a database held by the market server 300. In the example of FIG. 7, an evaluation point, a record of past transactions, and an associated power unit are associated with each agent ID. The agent ID (identification) is information for identifying the agent device 100. The “evaluation point” is one example of a participant evaluation (index) used to evaluate the user of the agent device 100 (hereinafter also referred to as a “participant”). The evaluation point will be described later.

The “record of past transactions” shows a record of past transactions executed in the power transaction system 80 by the agent device 100 identified by the agent ID. The record of past transactions includes a record of past buys of power and a record of past sells of power. The record of past transactions is a history of transactions based on accepted bids. The record of past transactions is stored in the agent database both when a transaction is automatically executed by the agent device 100 and when a transaction is manually executed by the user.

Next, the associated power unit will be described. As described above, each agent device 100 is associated with at least one of the power unit 451 and the electrically operated device 453. The “associated power unit” is information showing the associated device.

In the example of FIG. 7, the evaluation point associated with the agent ID A1 is 10 points. The record of past transactions associated with the agent ID A1 includes a record of buying X1 kWh of renewable energy-derived power for Y1 yen in the time span of 13:00 to 15:00 on Jan. 6, 2020. The associated power unit associated with the agent ID A1 is a storage battery E. The storage battery is one example of the power unit 451 and can discharge and store power.

The associated power unit associated with the agent ID A2 is an electrified vehicle that can execute autonomous driving. The associated power unit associated with the agent ID A3 is an electrified vehicle for which the travel route has been determined. The ellipsis marks in the example of FIG. 7 indicate that data is actually stored but omitted from the table.

The pieces of information specified in the participant database other than the agent ID correspond to the “participant information” of this disclosure.

Functional Block Diagram

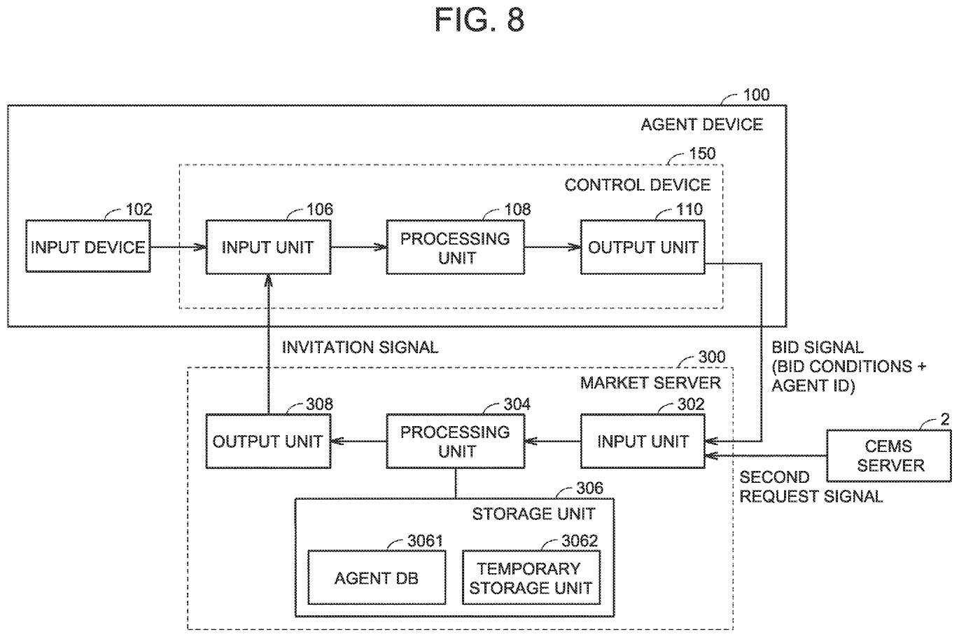

FIG. 8 is a functional block diagram of the agent device 100 and the market server 300. In the example of FIG. 8, the agent device 100 has the input device 102 and the control device 150. The control device 150 has an input unit 106, a processing unit 108, and an output unit 110.

The market server 300 has an input unit 302, a processing unit 304, a storage unit 306, and an output unit 308. The input unit 302 and the output unit 308 correspond to examples of the “interface” of this disclosure. These interfaces can communicate with the plurality of agent devices 100 and the CEMS server 2 (other management device). The processing unit 304 corresponds to one example of the “processor” of this disclosure. The storage unit 306 corresponds to one example of the “memory” of this disclosure. The storage unit 306 includes an agent database 3061 and a temporary storage unit 3062. The agent database 3061 is the database described with FIG. 7.

As described in step (B) of FIG. 1, the CEMS server 2 sends the second request signal to the market server 300. The second request signal is input into the input unit 302. The processing unit 304 receives the input second request signal. The processing unit 304 determines the bid time span based on the requested time span of the second request signal. For example, the processing unit 304 sets a time of day that is before the requested start time of the requested time span as the bid end time (see FIG. 2). Further, the processing unit 304 sets a time of day that is a predetermined time (the time of the bid time span) before that bid end time as the bid start time. The processing unit 304 generates an invitation signal. The invitation signal includes the bid time span determined by the processing unit 304 and the requested time span included in the second request signal (FIG. 3). The processing unit 304 sends the invitation signal to the plurality of agent devices 100 via the output unit 308 (see step (C) of FIG. 1).

The invitation signal is input into the input unit 106 of the control device 150 of the agent device 100. The invitation signal input into the input unit 106 is output to the processing unit 108. The processing unit 108 determines the bid conditions based on the aforementioned bid algorithm or an input from the user. As described above, the bid conditions include the traded power amount, the transaction time span, and the traded power price. The processing unit 108 generates a bid signal. The bid signal includes the agent ID and the bid conditions. The processing unit 108 sends the bid signal to the market server 300 via the output unit 110. The processing unit 108 holds the agent ID of the agent device 100 including the processing unit 108.

Among the plurality of agent devices 100, there are agent devices that do not determine the bid conditions. For example, such agent devices are agent devices that cannot execute a power transaction according to the requested time span specified by the bid signal. In this embodiment, agent devices among the plurality of agent devices 100 that have determined the bid conditions (have sent the bid signal to the market server 300) are also referred to as “at least one or more agent devices.”

The bid signals sent from the at least one or more agent devices 100 are input into the input unit 302 of the market server 300. The input at least one or more bid signals are output to the processing unit 304. The processing unit 304 stores the bid conditions included in each of the at least one or more bid signals in the temporary storage unit 3062 so as to be associated with the agent ID included in the bid signal.

The processing unit 304 accepts the bid by the bid conditions included in each of the at least one or more bid signals. The processing unit 304 regards the bid conditions as eligible for acceptance when, for example, the bid conditions meet the following first condition, second condition, and third condition. The first condition is a condition that the transaction time span of the bid conditions is included in the requested time span included in the invitation signal. The second condition is a condition that the transaction price of the bid conditions falls within a normal price range. The third condition is a condition that the traded power amount of the bid conditions falls within a normal power range. The processing unit 304 does not regard the bid conditions as eligible for acceptance when at least one of the first to third conditions is not met. The processing unit 304 sets the normal price range and the normal power range based on the second request signal.

Then, the processing unit 304 integrates the results of the accepted bid conditions from the one or more agent devices 100 to generate a second result signal, and sends the second result signal to the CEMS server 2 via the output unit 308.

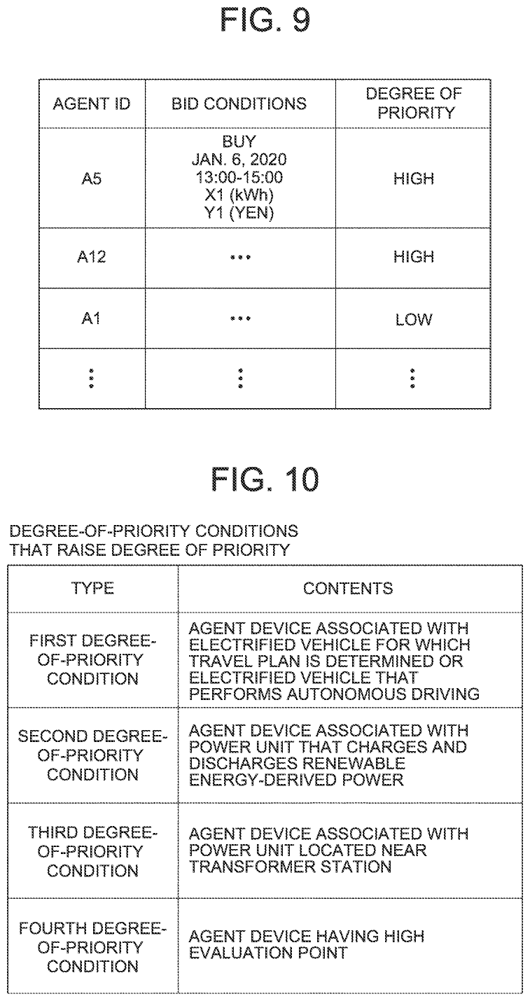

FIG. 9 is a table showing the bid conditions that are temporarily stored in the temporary storage unit 3062. In the example of FIG. 9, bid conditions and a degree of priority are stored in association with each agent ID. The degree of priority is an index used to determine whether the bid by the agent device can be accepted. The bid of an agent device having a high degree of priority is accepted with priority. The degree of priority will be described later.

In the example of FIG. 9, the bid conditions of the agent device with the agent ID A5 specify a transaction time span of 13:00 to 15:00 on Jan. 6, 2020, a traded power amount of X1 (kWh), and a traded power price of Y1 (yen), and the degree of priority is specified as “high.” The degree of priority of the agent device with the agent ID A12 is specified as “high.” The degree of priority of the agent device with the agent ID A1 is specified as “low.” The bid conditions of the agent device with the agent ID A12 etc. are represented by ellipse marks, which means that the bid conditions actually exist but are not shown.

The difference between the function of the individual server 130 and the function of the market server 300 will be briefly described. As described above, the individual server 130 functions to adjust the power of the amount of power shown by the first request signal. On the other hand, the market server 300 does not have this function and functions to invite bid conditions from the agent devices 100.

Degree of Priority

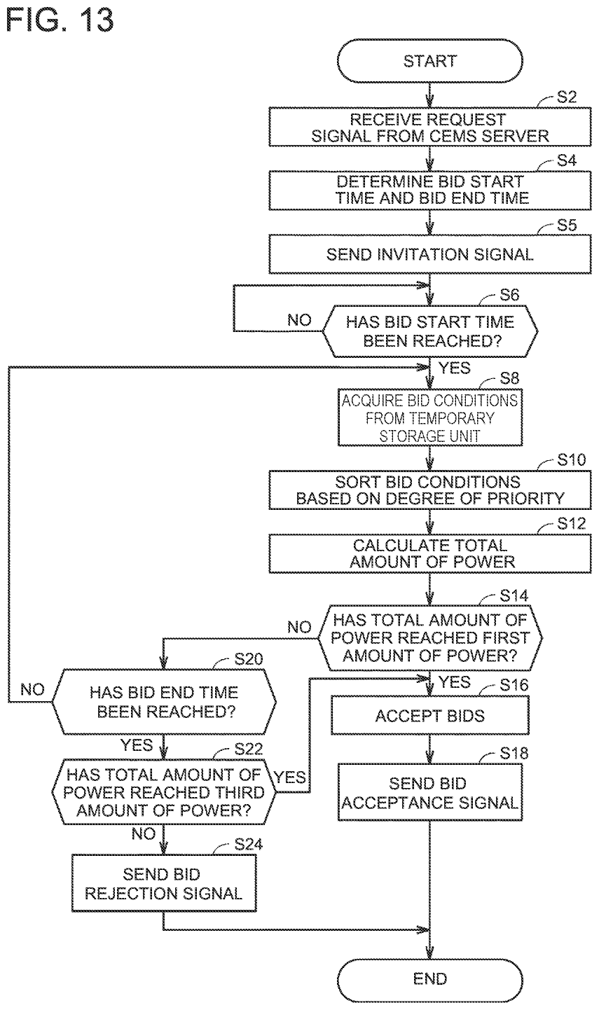

Next, degree-of-priority conditions will be described. When the processing unit 304 receives bid conditions, the processing unit 304 sets the degree of priority for the agent device 100 that has sent the bid conditions. The degree of priority is set to be high when the agent device 100 meets the degree-of-priority conditions described below. The market server 300 selects the bid conditions based on the degree of priority. In this embodiment, as shown in FIG. 13 to be described later, bid conditions of which the degree of priority is “low” are excluded, and only the bids by bid conditions of which the degree of priority is “high” are accepted. Thus, the market server 300 can realize a smoother power transaction by accepting bids from the agent devices having a high degree of priority.

FIG. 10 is a table describing the degree-of-priority conditions. In the example of FIG. 10, the degree-of-priority conditions include a first degree-of-priority condition, a second degree-of-priority condition, a third degree-of-priority condition, and a fourth degree-of-priority condition.

First, the first degree-of-priority condition will be described. In the following, at least one of an “electrified vehicle for which a travel plan is determined” and an “electrified vehicle that performs autonomous driving” will also be referred to as a “specific vehicle.” The first degree-of-priority condition is a condition that is met by an agent device 100 associated with the specific vehicle that is one example of the electrically operated device 453. In other words, the agent device 100 meets the first degree-of-priority condition when the associated power unit (see FIG. 7) associated with that agent device 100 is the specific vehicle, i.e., at least one of an “electrified vehicle for which a travel plan is determined” and an “electrified vehicle that performs autonomous driving.”

The reason is as follows. An agent device 100 associated with the specific vehicle that is the electrically operated device 453 and an “electrified vehicle for which a travel plan is predetermined” or an “electrified vehicle that performs autonomous driving” can determine the traded power amount and the transaction time span for the specific vehicle as the bid conditions. Therefore, the electrically operated device 453 is predicted to execute power processing in accordance with the traded power amount and the transaction time span determined by the agent device 100. The power processing is processing of at least one of charging and discharging of power being traded. As the power transaction is thus executed according to the traded power amount and the transaction time span, a smooth power transaction is realized in the power management system 1000. It is therefore preferable that the bid of the agent device 100 associated with the specified vehicle be prioritized. The electrically operated device 453 may be, for example, a storage battery.

On the other hand, with a power unit different from the specific vehicle, the power transaction may not be executed according to the traded power amount and the transaction time span determined by the agent device 100 associated with that power unit. Therefore, the processing unit 304 sets the degree of priority such that an agent device that is associated with the specific vehicle has a higher degree of priority than an agent device that is not associated with the specific vehicle. Thus, the market server 300 can reduce the occurrence of a problem that a power transaction is not executed according to the bid conditions from the agent device 100.

Next, the second degree-of-priority condition will be described. In this embodiment, the power traded in the power management system 1000 includes first traded power and second traded power. The first traded power is power of which generating a unit amount emits a first amount of carbon dioxide. The unit amount is a predetermined amount. The second traded power is power of which generating the unit amount emits a second amount, smaller than the first amount, of carbon dioxide. Thus, the amount of carbon dioxide emitted to generate the same unit amount of power is smaller for the second traded power than for the first traded power.

For example, the first traded power is power that is generated using depletable energy. Examples of depletable energy include petroleum, natural gas, oil sand, methane hydrate, and uranium.

The second traded power is power that is generated using renewable energy. Examples of renewable energy include energy of wind power, sunlight, hydraulic power, biomass, etc. In this embodiment, renewable energy-derived power is one example of the second traded power and ordinary power is one example of the first traded power.

From the viewpoint of global environmental protection, trading the second traded power is preferable to trading the first traded power. Therefore, the degree of priority is set such that an agent device 100 associated with the power unit 451 that executes power processing of the second traded power has a higher degree of priority than an agent device 100 associated with the power unit 451 that executes power processing of the first traded power. Thus, the market server 300 can encourage the agent devices 100 or the owners of the agent devices 100 to execute power transactions that contribute to global environmental protection.

Next, the third degree-of-priority condition will be described. As described in FIG. 1, power from the power system 4 is output to the plurality of power units 451 via the plurality of power receiving-transforming facilities 3. Among the plurality of power receiving-transforming facilities 3, a power receiving-transforming facility that is directly electrically connected to the plurality of power units 451 is referred to as a “specific power receiving-transforming facility.” The specific power receiving-transforming facility corresponds to one example of the “power relay facility” according to this disclosure. The specific power receiving-transforming facility and the power units 451 are connected to each other by power lines. When the distance between the specific power receiving-transforming facility and the power unit 451 is long, a long power line connecting the specific power receiving-transforming facility and the power unit 451 is needed and this power line has high electric resistance. Accordingly, a greater power loss occurs over the power line.

Therefore, to reduce the power loss, executing an exchange of power between the power system 4 and a power unit 451 that is located at a shorter distance from the specific power receiving-transforming facility is preferable to executing an exchange of power between the power system 4 and a power unit 451 that is located at a longer distance from the specific power receiving-transforming facility. For example, a distance threshold value for the distance between the specific power receiving-transforming facility and the power unit 451 is specified. The processing unit 304 sets the degree of priority such that an agent device 100 associated with a power unit 451 that is located at a first distance (a distance shorter than the distance threshold value) from the specific power receiving-transforming facility has a higher degree of priority than an agent device 100 associated with an electrically operated device 453 that is located at a second distance, longer than the first distance (a longer distance than the distance threshold value), from the specific power receiving-transforming facility. Thus, the market server 300 can reduce the power loss over the power line.

Next, the fourth degree-of-priority condition will be described. The processing unit 304 acquires the evaluation point corresponding to the agent ID sent along with the bid conditions with reference to the agent database. The fourth degree-of-priority condition is met when the evaluation point acquired (see FIG. 7) is higher than a predetermined evaluation threshold value. Specifically, the processing unit 304 sets the degree of priority such that an agent device 100 having a first point (a higher point than the evaluation threshold value) as the evaluation point has a higher degree of priority than an agent device having a second point, lower than the first point (a lower point than the evaluation threshold value), as the evaluation point. Thus, the market server 300 can encourage the owners of the agent devices 100 to make the power transactions and the bid conditions more suitable. The conditions for increasing and decreasing the evaluation point will be described later.

In this embodiment, the processing unit 304 gives P1 as a degree-of-priority point to an agent device 100 that has met the first degree-of-priority condition. The processing unit 304 gives P2 as the degree-of-priority point to an agent device 100 that has met the second degree-of-priority condition. The processing unit 304 gives P3 as the degree-of-priority point to an agent device 100 that has met the third degree-of-priority condition. The processing unit 304 gives P4 as the degree-of-priority point to an agent device 100 that has met the fourth degree-of-priority condition.

The processing unit 304 calculates a total degree-of-priority point P by the following Formula (3):

Total degree-of-priority point P=P1×P2×P3×P4 (3)

Then, the processing unit 304 sets the degree of priority as “high” when the total degree-of-priority point P is equal to or higher than a predetermined threshold value, and sets the degree of priority as “low” when the total degree-of-priority point P is lower than the threshold value.

Evaluation Point

Next, the evaluation point will be described. The evaluation point is set (updated) based on a transaction history of the agent device 100. In this embodiment, the market server 300 updates the evaluation point when a first update condition or a second update condition is met. The market server 300 increases the evaluation point when a transaction favorable for the power transaction system 80 is executed, and decreases the evaluation point when a transaction unfavorable for the power transaction system 80 is executed.

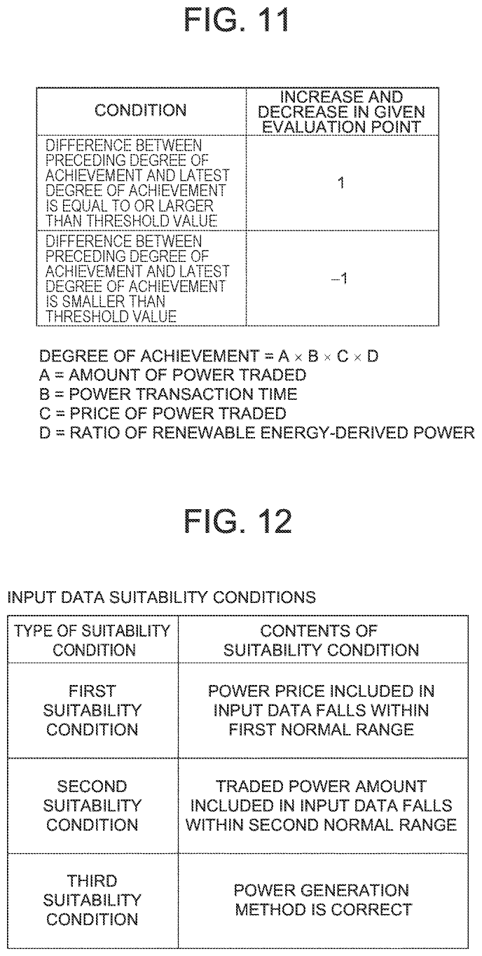

FIG. 11 is a table showing one example of an increase and a decrease in the evaluation point when the first update condition is met. The processing unit 304 of the market server 300 increases and decreases the evaluation point based on the transaction history of the agent device 100. In this embodiment, the market server 300 increases and decreases the evaluation point based on a degree of achievement that is calculated from the transaction history of the agent device 100. The degree of achievement is an index showing the degree of intervention in power transactions in the power transaction system 80. In the example of FIG. 11, the market server 300 calculates the degree of achievement by the following Formula (4):

Degree of achievement=A×B×C×D (4)

In the example of Formula (4), the market server 300 calculates the degree of achievement by multiplying a real number A, a real number B, a real number C, and a real number D.

The real number A on the right side of Formula (4) represents a total amount of amounts of power traded in past transactions by the agent device 100. The real number B on the right side of Formula (4) represents a total amount of time of power transactions executed in the past by the agent device 100. The real number C on the right side of Formula (4) represents a total price of prices of power traded in past transactions by the agent device 100. The real number D on the right side of Formula (4) represents a total amount of ratios of renewable energy-derived power traded in the past by the agent device 100. The ratio of renewable energy-derived power is calculated, for example, by the following Formula (5):

Ratio of renewable energy-derived power=total amount of renewable energy-derived power traded in the past/total amount of all types of power traded in the past (5) In the example of Formula (5), the market server 300 calculates the ratio of the renewable energy-derived power (real number D) by dividing the “total amount of renewable energy-derived power traded in the past” by the “total amount of all types of power traded in the past.” The total amount of all types of power traded in the past is the total amount of ordinary power and renewable energy-derived power.

The market server 300 can acquire the real number A to the real number D, for example, from the record of past transactions in the agent database (see FIG. 7).

As a modified example, the market server 300 may calculate the degree of achievement using one to three real numbers among the real number A, the real number B, the real number C, and the real number D. Or the market server 300 may calculate the degree of achievement using the sum of at least two of the real number A to the real number D.

As shown in FIG. 11, the market server 300 calculates the difference between the preceding degree of achievement (i.e., the degree of achievement one month ago) and the latest degree of achievement (i.e., the degree of achievement at the current point in time). Specifically, the market server 300 calculates the difference by subtracting the preceding degree of achievement from the latest degree of achievement. When the difference is equal to or larger than a predetermined threshold value, the market server 300 increases the evaluation point by a predetermined amount (in this embodiment, one point). On the other hand, when the difference is smaller than the threshold value, the market server 300 decreases the evaluation point by a specific amount (in this embodiment, one point). Here, the threshold value is a predetermined value, and, for example, can be changed by a manager of the market server 300 etc.

That the difference is equal to or larger than the threshold value means that the agent device 100 has executed many power transactions during the period from when the preceding degree of achievement was calculated to when the latest degree of achievement was calculated (i.e., one month). Therefore, the market server 300 increases the evaluation point of such an agent device 100. On the other hand, that the difference is smaller than the threshold value means that the agent device 100 has performed few power transactions or no power transactions during the period from when the preceding degree of achievement was calculated to when the latest degree of achievement was calculated. Therefore, the market server 300 decreases the evaluation point of such an agent device 100.

Next, the second update condition will be described. The second update condition includes a condition that a power transaction has started or a condition that a power transaction has ended. Hereinafter, data (bid conditions) input by the bidder into the input screen 350 of FIG. 5 is referred to as “input data.” When the second update condition is met and the contents of the input data meet suitability conditions, the market server 300 increases the evaluation point corresponding to this input data by a predetermined amount (e.g., one point). On the other hand, when the second update condition is met and the contents of the input data do not meet the suitability conditions, the market server 300 decreases the evaluation point corresponding to this input data by a specific amount (e.g., one point).

FIG. 12 is a table describing the suitability conditions. In the example of FIG. 12, the suitability conditions include a first suitability condition, a second suitability condition, and a third suitability condition. The suitability conditions of FIG. 12 are conditions mainly used for normal P2P power transactions.

The first suitability condition includes that the traded power price that is included in the input data is within a first normal range. The first normal range is a predetermined range. The first normal range may be determined by the market server 300 using a predetermined algorithm. Or the first normal range may be manually determined by the manager of the market server 300 etc.

When a power buyer inputs an abnormally high traded power price (i.e., when the traded power price exceeds the first normal range), for example, a problem that this power buyer may buy up the power in the power transaction market can arise. Therefore, it is preferable for the market server 300 to decrease the evaluation point of such a power buyer.

When a power buyer inputs an abnormally low traded power price (i.e., when the traded power price falls below the first normal range), for example, a problem that the power price in the power transaction market becomes abnormally low can arise. Therefore, it is preferable for the market server 300 to decrease the evaluation point of such a power buyer.

When a power seller inputs an abnormally high traded power price (i.e., when the traded power price exceeds the first normal range), for example, a problem that the power price in the power transaction market becomes abnormally high can arise. Therefore, it is preferable for the market server 300 to decrease the evaluation point of such a power seller.

When a power seller inputs an abnormally low traded power price (i.e., when the traded power price falls below the first normal range), for example, a problem that a power buyer may buy up the power in the power transaction market can arise. Therefore, it is preferable for the market server 300 to decrease the evaluation point of such a power seller.

On the other hand, when the traded power price input by a power buyer or a power seller is within the first normal range, these problems are less likely to arise and a smooth power transaction is executed. Therefore, it is preferable for the market server 300 to increase the evaluation point of such a power buyer or a power seller.

The second suitability condition includes that the traded power amount that is included in the input data (the traded power amount that is input into the input screen 350 of FIG. 5) is within a second normal range. The second normal range is a predetermined range. The second normal range may be determined by the market server 300 using a predetermined algorithm. Or the second normal range may be manually determined by the manager of the market server 300 etc.

When a power buyer inputs an abnormally large traded power amount (i.e., when the traded power amount exceeds the second normal range), for example, a problem that this power buyer may buy up the power in the power transaction market can arise. Therefore, it is preferable for the market server 300 to decrease the evaluation point of such a power buyer.

When a power buyer inputs an abnormally small traded power amount (i.e., when the traded power amount falls below the second normal range), for example, a problem that confusion occurs in power transactions in the power transaction market can arise. Therefore, it is preferable for the market server 300 to decrease the evaluation point of such a power buyer.

When a power seller inputs an abnormally large traded power amount (i.e., when the traded power amount exceeds the second normal range), for example, a problem that a power buyer may buy up the power in the power transaction market can arise. Therefore, it is preferable for the market server 300 to decrease the evaluation point of such a power seller.

When a power seller inputs an abnormally small traded power amount (i.e., the traded power amount falls below the second normal range), for example, a problem that confusion occurs in power transactions in the power transaction market can arise. Therefore, it is preferable for the market server 300 to decrease the evaluation point of such a power seller.

On the other hand, when the traded power amount input by a power buyer or a power seller is within the second normal range, these problems are less likely to arise and a smooth power transaction is executed. Therefore, it is preferable for the market server 300 to increase the evaluation point of such a power buyer or a power seller.

Next, a third suitability condition will be described. In a normal P2P power transaction, the type of power being traded is input into a type input field (not shown) of the input screen. In this embodiment, the types of power include renewable energy-derived power and ordinary power.

For example, a power seller inputs into the input screen 350 whether the power being sold is renewable energy-derived power or not. Here, information input into the type input field is information showing a power generation method, and therefore this information corresponds to the “generation information” of this disclosure. The third suitability condition is a condition that the market server 300 acquires information showing that this generation information is correct.

In some cases, a malicious power seller may commit a fraud of selling power by inputting that the power is renewable energy-derived power into the type input field despite it actually not being renewable energy-derived power. It is preferable for the market server 300 to decrease the evaluation point of a power seller who commits such a fraud. On the other hand, when a power seller sells renewable energy-derived power by inputting that the power is renewable energy-derived power into the type input field, this power seller contributes to global environmental protection. Therefore, it is preferable that the evaluation point of this power seller be increased.

Examples of methods for determining whether the power traded is renewable energy-derived power include a method in which the manager of the market server 300 etc. inspects the power unit of a power seller who has sold the power with a renewable energy label attached to the unit.

When the manager determines that the generation information is correct as a result of inspecting the power unit 451, the manager inputs correctness information showing that the generation information is correct into the market server 300 using an input device (not shown). In this case, the market server 300 acquires this correctness information. When the correctness information is acquired, the evaluation point of the power seller is increased, with the input data regarded as meeting the third suitability condition.

On the other hand, when the manager determines that the generation information is false as a result of inspecting the power unit 451 (i.e., when the power seller has committed a fraud), the manager inputs incorrectness information showing that the generation information is incorrect into the market server 300 using the input device. In this case, the market server 300 acquires this incorrectness information. When the incorrectness information is acquired, the evaluation point of the power seller is decreased, with the input data regarded as not meeting the third suitability condition.

Alternatively, the market server 300 may analyze power from the power unit 451 of the power seller to determine whether the power is renewable energy-derived power.

Process Flow of Market Server 300

FIG. 13 is a flowchart showing a main process of the market server 300. First, in step S2, a second request signal is received from the CEMS server 2 of the market server 300 (see step (B) in FIG. 1). Next, in step S4, the market server 300 determines the bid start time and the bid end time as shown in FIG. 2. Next, in step S5, the market server 300 generates an invitation signal including the bid start time and the bid end time, and sends the invitation signal to the plurality of agent devices 100 (see step (C) in FIG. 1).

Next, in step S6, the market server 300 determines whether the current time has reached the bid start time determined in step S4. The market server 300 waits until it determines that the bid start time determined in step S4 is reached (NO in step S6).

When the determination result of step S6 becomes YES, the process moves to step S8. In step S8, the market server 300 acquires bid conditions stored in the temporary storage unit 3062. Next, in step S10, the market server 300 sorts the bid conditions based on the degree of priority specified for the acquired bid conditions. In this embodiment, the market server 300 extracts bid conditions for which the degree of priority is “high” and discards bid conditions for which the degree of priority is “low.” In step S10, those bid conditions among the extracted bid conditions that meet the above-described first to third conditions are further sorted.

Next, a total amount of power of the traded power amounts (i.e., the second amounts of power) that are included in the bid conditions extracted in step S12 (i.e., the bid conditions for which the degree of priority is “high”) is calculated (updated).

Next, in step S14, the market server 300 determines whether the total amount of power updated in step S12 has reached the first amount of power (i.e., the amount of power Ap in the above-described Formula (1)). When the total amount of power has reached the first amount of power (YES in step S14), i.e., when the request by the second request signal from the CEMS server 2 can be met, the process moves to step S16. In step S16, the market server 300 accepts all the bid conditions of the second amounts of power used to calculate the total amount of power that was determined to reach the first amount of power in step S14 (the bid conditions sorted out in step S10).

Next, in step S18 following step S16, the market server 300 sends a bid acceptance signal to the agent devices 100 that sent the bid conditions of the second amounts of power used to calculate the total amount of power that was determined to reach the first amount of power in step S14. The bid acceptance signal is a signal showing that the bid is accepted. The agent device 100 recognizes that the bid is accepted by receiving this bid acceptance signal. The market server 300 sends the bid acceptance signal to the CEMS server 2 as the second result signal.

When the determination result of step S14 is NO, i.e., when the request by the second request signal from the CEMS server 2 is not met, the process moves to step S20. In step S20, the market server 300 determines whether the current time has reached the bid end time determined in step S4.

When the current time has not reached the bid end time (NO in step S20), the process returns to step S8. When the current time has reached the bid end time (YES in step S20), the process moves to step S22.

In step S22, the market server 300 determines whether the total amount of power has reached a third amount of power. Here, the third amount of power is an amount of power smaller than the first amount of power. The third amount of power is a value calculated by multiplying the first amount of power by a predetermined ratio (a real number smaller than one). The third amount of power is a predetermined value. It is preferable that the third amount of power be, for example, 1 MWh or larger.

When the total amount of power has reached the third amount of power in step S22 (YES in step S22), the process moves to step S16. In step S18 following step S16, the market server 300 sends a bid acceptance signal showing that the total amount of power is the third amount of power (that the total amount of power has failed to reach the first amount of power) to the CEMS server 2.

When the determination result of step S22 is NO, in step S24, the market server 300 sends a bid rejection signal to the CEMS server 2 as the second result signal. Further, in step S24, the market server 300 sends the bid rejection signal to all the agent devices. The agent devices 100 recognize that the bid has been rejected by receiving the bid rejection signal.

In a conventional VPP, a power company sometimes outputs a major request for a transaction of a large amount of power (e.g., in the unit of MWh) to an aggregation coordinator. In this case, the aggregation coordinator creates N minor requests into which the large amount of power specified by the major request is divided. Then, the aggregator coordinator sends the N minor requests respectively to N resource aggregators. The resource aggregator executes a power transaction in accordance with the minor request with one or more power resources associated with the resource aggregator. The aggregation coordinator realizes a power transaction in accordance with the major request by aggregating the power transactions in accordance with the N minor requests.

Here, for example, a case where the power specified by the minor request is 9 MWh and the power resource is an electrified vehicle will be described. In this case, the amount of power exchanged by the electrified vehicle is commonly 3 kWh to 6 kWh. Therefore, to meet this minor request, about 1500 electrified vehicles (about 1500 power resources) are required. However, when electrified vehicles are not sufficiently widespread, it is difficult to prepare as many as 1500 electrified vehicles. In addition, electrified vehicles that are traveling cannot usually meet the minor request. To meet the minor request, it is conceivable to prepare other adjustment resources (e.g., stationary storage batteries) than electrified vehicles. However, preparing other adjustment resources can involve a high cost.

Thus, in the conventional VPP, there is a case such as where the power resources that can deal with a power transaction in accordance with a minor request are small in number. In this case, the aggregation coordinator may not be able to realize a power transaction in accordance with the major request. Thus, with power transactions frequently executed these days, there is a need for a technology that can realize a more flexible power transaction.

By contrast, the CEMS server 2 in this embodiment can output a minor request (second request signal) also to the market server 300 of the power transaction system 80 (P2P system). Therefore, even when the power resources of a resource coordinator are insufficient, the CEMS server 2 can make a power transaction not only with the power resources of the resource coordinator but also with the plurality of agent devices 100 of the power transaction system 80. Thus, the market server 300 can realize a more flexible power transaction than the conventional system.

The case where a request signal is output from the company server 5 is a relatively urgent case such as the first situation or the second situation described above. When the company server 5 has outputted such a request signal, for example, the owner of the company server 5 may pay a reward to bidders who have cooperated on the request of this request signal. The reward is, for example, cash. When such a reward is paid, the users owning the agent devices 100 can buy power at a lower price or sell power at a higher price. Thus, the market server 300 allows the users of the agent devices 100 to execute power transactions under favorable conditions.

For example, the power system 4 has a configuration based on the assumption of input or output of amounts of power in the unit of MWh, and does not have a configuration based on the assumption of input or output of amounts of power in the unit of kWh (i.e., the second amounts of power). Thus, it is difficult for the power system 4 to input or output amounts of power in the unit of kWh.

In this embodiment, therefore, acceptance conditions for the bid specified by the second request signal include, as shown in step S14 and step S16 of FIG. 13, a condition that is met when a total value (total amount of power) of the second amounts of powers (typically in the unit of kWh) included in the bid conditions shown by the bid signals received from at least one or more agent devices reaches the first amount of power (typically in the unit of MWh). Thus, a power transaction according to the request from the company server 5, i.e., the request of the second request signal from the CEMS serve 2 (i.e., selling or buying of power in the unit of MWh) can be realized.

As shown in step S20 and step S22 of FIG. 13, the acceptance conditions further include a condition that is met when the total amount of power reaches the third amount of power and moreover the time of day (bid end time) specified by the market server 300 is reached. Therefore, even when the total value of power is smaller than the first amount of power that is an amount requested by the CEMS server 2, the bids are accepted when the bid end time specified by the market server 300 is reached. Thus, the market server 300 can reduce the loss of opportunities for power transactions.

As shown in FIG. 10 and step S10, the market server 300 accepts the bids by at least one or more agent devices based on the degree of priority set for each of the at least one or more agent devices. Thus, by accepting the bids by agent devices having a high degree of priority, the market server 300 can realize a smoother power transaction.

Modified Example

(1) In the configuration described with FIG. 13, the market server 300 accepts the bids at the point when the total amount of power reaches the first amount of power (see step S14 and step S16) during the bid time span from the bid start time to the bid end time (see FIG. 2).

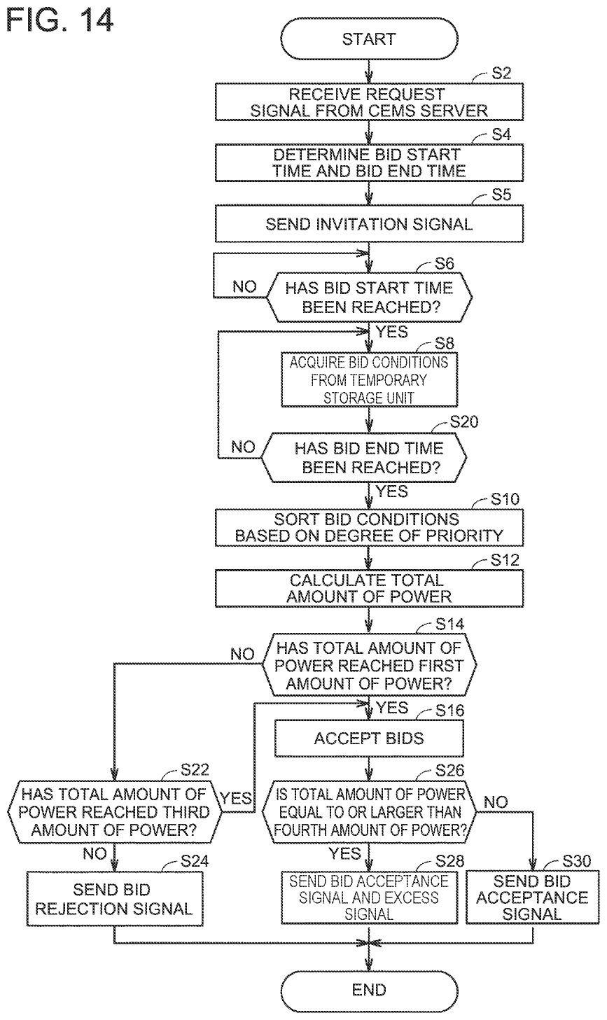

Alternatively, the market server 300 may adopt a configuration in which it acquires the bid conditions sent from the agent devices 100 during the entire period of the bid time span and accepts the bids. FIG. 14 is a flowchart for the operation of the market server 300 adopting this configuration. When FIG. 14 and FIG. 13 are compared, in FIG. 13, processing of step S20 is executed when the determination result of step S14 is NO, whereas in FIG. 14, processing of step S20 is executed after step S8. Further, in the example of FIG. 14, processing of step S26 is executed after step S16.

After ending the processing of step S8, the market server 300 determines in step S20 whether the current time has reached the bid end time. When the determination result of step S20 is NO, the process returns to step S8. When the determination result of step S20 is YES, the process moves to step S10.

Thus, by processing of step S8 and step S20, the market server 300 can acquire the bid conditions sent from the agent devices 100 during the entire period of the bid time span. Then, after processing of step S16, the market server 300 determines in step S26 whether the total amount of power is equal to or larger than a fourth amount of power.

Here, for example, the fourth amount of power is an amount larger than the first amount of power. That the total amount of power becomes equal to or larger than the fourth amount of power means that the total amount of power is an excessively large amount of power. For example, the fourth amount of power is an amount of power larger than the first amount of power by 1 MWh or more.

When the determination result of step S26 is YES, i.e., when the total amount of power is excessively large, in step S28, the market server 300 sends an excess signal to the CEMS server 2. This excess signal is a signal showing that the total amount of power has reached the fourth amount of power. Thus, when the total amount of power has reached the fourth amount of power, the market server 300 sends the excess signal showing that the total amount of power has reached the fourth amount of power to the CEMS server 2. Thus, the market server 300 allows the CEMS server 2 to recognize that the total amount of power has exceeded the first amount of power that is an amount requested by the CEMS server 2. Therefore, the CEMS server 2 can execute control such as making other resources process the power corresponding to the difference between the total amount of power and the first amount of power. Examples of this processing of the power include processing by which the CEMS server 2 buys power corresponding to the difference from other resources and processing by which the CEMS server 2 sells power corresponding to the difference to other resources.

(2) In the configurations described with the examples of FIG. 13 and FIG. 14, the market server 300 discards the bid conditions of a “low” degree of priority and uses the total amount of power of the traded power amounts that are included in the bid conditions of a “high” degree of priority. However, the market server 300 may use the traded power amounts that are included in the bid conditions of a “low” degree of priority. For example, when the determination result of step S14 shown in FIG. 13 and FIG. 14 is NO, i.e., when the total amount of power (i.e., the total amount of the traded power amounts that are included in the bid conditions of a “high” degree of priority) fails to reach the first amount of power before the current time reaches the bid end time, the market server 300 may add the total amount of the traded power amounts that are included in the bid conditions of a “low” degree of priority to that total amount of power. When the total amount of power calculated by this addition reaches the first amount of power, processing of step S16 is executed, and when the total amount of power fails to reach the first amount of power, processing of step S22 is executed.

(3) In this embodiment, the configuration in which there are two levels (“high” and “low”) of the degree of priority has been described. However, there may be three or more levels of the degree of priority. This configuration allows the market server 300 to sort the bid conditions more finely based on the degree of priority.

(4) In the above-described embodiment, the configuration in which the bid time span exists has been described (see FIG. 2). However, the bid time span may be omitted. For example, a configuration may be adopted in which the agent devices 100 included in the power transaction system 80 determine the bid conditions immediately upon receiving the invitation signal and send the bid signal including the invitation conditions to the market server 300. The power transaction system 80 adopting this configuration does not need the bid time span.

The embodiment disclosed this time should be construed as in every respect illustrative and not restrictive. The scope of this disclosure is defined not by the description of the above embodiment but by the claims and is intended to include all changes that are equivalent in meaning and scope to the claims.

What is claimed is:

1. A management device of a power transaction market, comprising:
a processor; and
an interface capable of communicating with a plurality of agent devices and another management device, wherein:
each of the plurality of agent devices determines bid conditions for a power buying or selling transaction in the power transaction market; and
the processor is configured to:
receive a request signal for requesting reception-supply adjustment of a first amount of power from the other management device;
send an invitation signal for inviting bids in accordance with the request signal to the plurality of agent devices;
receive a bid signal showing the bid conditions for a power buying or selling transaction of a second amount of power, smaller than the first amount of power, from at least one or more agent devices that have determined the bid conditions among the plurality of agent devices having received the invitation signal; and
accept bids by the at least one or more agent devices when acceptance conditions are met.

2. The management device according to claim 1, wherein the acceptance conditions include a condition that is met when a total value of second amounts of power included in bid conditions shown by the bid signals received from the at least one or more agent devices reaches the first amount of power.

3. The management device according to claim 1, wherein the acceptance conditions include a condition that is met when a total value of second amounts of power included in bid conditions shown by the bid signals received from the at least one or more agent devices reaches a third amount of power, smaller than the first amount of power, and moreover a time of day specified by the management device is reached.

4. The management device according to claim 1, wherein, when a total value of second amounts of power shown by the bid signals received from the at least one or more agent devices reaches a fourth amount of power, larger than the first amount of power, the management device sends an excess signal showing that the total value has reached the fourth amount of power to the other management device.

5. The management device according to claim 1, wherein the management device accepts bids by the at least one or more agent devices based on a degree of priority that is set for each of the at least one or more agent devices.

6. The management device according to claim 5, wherein:
each of the plurality of agent devices is associated with an electrified vehicle that executes power processing that is at least one of charging and discharging of power being traded; and
the management device sets the degree of priority such that an agent device that is associated with a specific vehicle that is at least one of an electrified vehicle for which a travel plan is determined and an electrified vehicle that performs autonomous driving has a higher degree of priority than an agent device that is not associated with the specific vehicle.

7. The management device according to claim 5, wherein:
each of the plurality of agent devices is associated with a power unit that executes power processing that is at least one of charging and discharging of power being traded;
power traded in the power transaction market includes first traded power of which generating a unit amount emits a first amount of carbon dioxide, and second traded power of which generating the unit amount emits a second amount, smaller than the first amount, of carbon dioxide; and
the management device sets the degree of priority such that an agent device associated with a power unit that executes the power processing of the second traded power has a higher degree of priority than an agent device associated with a power unit that executes the power processing of the first traded power.

8. The management device according to any one of claim 5, wherein:
each of the plurality of agent devices is associated with a power unit that executes power processing that is at least one of charging and discharging of power being traded;
the power unit exchanges power via a power relay facility; and
the management device sets the degree of priority such that an agent device associated with a power unit that is located at a first distance from the power relay facility has a higher degree of priority than an agent device associated with a power unit that is located at a second distance, longer than the first distance, from the power relay facility.

9. The management device according to claim 5, further comprising a memory that stores an agent ID of an agent device and an evaluation point of the agent device so as to be associated with each other, wherein:
the management device updates the evaluation point based on at least one of a history of past transactions executed by the agent device and contents of the bid conditions shown by the bid signal received from the agent device; and
the management device sets the degree of priority such that an agent device of which the evaluation point is a first point has a higher degree of priority than an agent device of which the evaluation point is a second point, lower than the first point.

10. A method using a plurality of agent devices and a management device of a power transaction market,
each of the plurality of agent devices being configured to determine bid conditions for a power buying or selling transaction in the power transaction market, the method comprising:
receiving a request signal for requesting reception-supply adjustment of a first amount of power from another management device;
sending an invitation signal for inviting bids in accordance with the request signal to the plurality of agent devices;
receiving a bid signal showing the bid conditions for a power buying or selling transaction of a second amount of power, smaller than the first amount of power, from at least one or more agent devices that have determined the bid conditions among the plurality of agent devices having received the invitation signal; and
accepting bids by the at least one or more agent devices when acceptance conditions are met.

11. A power management system comprising:
a first management device that outputs a request signal requesting reception-supply adjustment of an amount of power;
a second management device that outputs a first request signal and a second request signal based on the request signal;
a power adjustment resource;
a third management device that adjusts power of the power adjustment resource based on the first request signal output from the second management device;
a fourth management device of a power transaction market; and
a plurality of agent devices, wherein:
the second request signal is a signal for requesting reception-supply adjustment of a first amount of power;
each of the plurality of agent devices determines bid conditions for a power buying or selling transaction in the power transaction market; and
the fourth management device is configured to:
send an invitation signal for inviting bids in accordance with the second request signal to the plurality of agent devices;
receive a bid signal showing the bid conditions for a power buying or selling transaction of a second amount of power, smaller than the first amount of power, from at least one or more agent devices that have determined the bid conditions among the plurality of agent devices having received the invitation signal; and
accept bids by the at least one or more agent devices when acceptance conditions are met.
